(19) United States
(12) Patent Application Publication
(10) Pub. No.: US 2026/0214000 A1
(43) Pub. Date: Jul. 23, 2026

(54) METHOD AND SYSTEM FOR RECONFIGURING ELECTRONIC NETWORK RESOURCE USAGE CONFIGURATIONS

(71) Applicant: JPMorgan Chase Bank, N.A., New York, NY (US)

(72) Inventors: Eoin KENNY, Cambridge, MA (US); Manuela VELOSO, New York, NY (US); Allan ANZAGIRA, Long Island City, NY (US); Tom BEWLEY, London (GB); Freddy LECUE, Mamaroneck, NY (US)

(73) Assignee: JPMorgan Chase Bank, N.A., New York, NY (US)

(21) Appl. No.: 19/029,085

(22) Filed: Jan. 17, 2025

(51) Int. Cl. H04L 41/0826; H04L 43/0876

(52) U.S. Cl. CPC H04L 41/0826; H04L 43/0876

(57) ABSTRACT

A system is presented that implements an electronic network reconfiguration tool that improves electronic network resource usage efficiency within an electronic network. The system may be configured to: utilize perturbation theory, to generate a reconfiguration guide from a reconfiguration dataset of the electronic network, by perturbing a plurality of network configurations and a plurality of usage factors of electronic network resource usage attributes; determine, by evaluating a first set of electronic network resource usage changes against the reconfiguration guide, a set of network configuration changes that improves the electronic network resource usage efficiency; and improve the electronic network resource usage efficiency by implementing the set of network configuration changes within the electronic network.

### BACKGROUND

### 1. Field

This disclosure generally relates to electronic network resources and, more particularly, to a method, system, and computer-readable medium for reconfiguring electronic network resource usage configurations to improve electronic network resource usage efficiency.

### 2. Background

Algorithmic recourse is a specialized variant of counterfactual explanation, concerned with offering actionable recommendations to individuals who have received adverse outcomes from automated systems. Most recourse algorithms assume access to a cost function, which quantifies the effort involved in following recommendations. Such functions are useful for filtering down recourse options to those which are most actionable.

In this disclosure, a technique is provided for determining cost and labeling data for the training of effective cost functions, a high-level schematic of the function parameters should be engineered into the labelling prompt to maximize performance.

Conventionally, recourse cost definitions have mainly relied on heuristics and missed the complexities of feature dependencies and fairness attributes, which has drastically limited their usefulness. These and other drawbacks exist. However, the approach provided herein may be utilized to train a high-performing, interpretable cost function via novel techniques.

Therefore, there is a need in in the field of the present disclosure, for a technological improvement that addresses these drawbacks and provides simple and accessible techniques for accurately quantifying notions of efficiency, cost, effort, or distance between data points.

Accordingly, the approach disclosed herein is presented to improve the field of the present disclosure by applying the above-mentioned technical solution to improve a technological field, such as electronic network resource usage efficiency.

### SUMMARY

The present disclosure, through one or more of its various aspects, embodiments, and/or specific features or sub-component, provides, inter alia, various systems, servers, devices, methods, media, programs and platforms for implementing an electronic network reconfiguration tool that improves electronic network resource usage efficiency within an electronic network.

According to an aspect of the invention, a method is provided that implements an electronic network reconfiguration tool that improves electronic network resource usage efficiency within an electronic network. The method may comprise: storing, as a reconfiguration dataset, electronic network resource parameters that describe electronic network resource usage attributes of the electronic network; utilizing perturbation theory, to generate a reconfiguration guide of the reconfiguration dataset, by perturbing a plurality of network configurations and a plurality of usage factors of the electronic network resource usage attributes; during a first state of operation that comprises a first electronic network resource usage state, receiving a first set of electronic network resource usage changes; based on the first state of operation, determining, by evaluating the first set of electronic network resource usage changes against the reconfiguration guide, a set of network configuration changes that improves the electronic network resource usage efficiency; and based on the first state of operation and the first set of electronic network resource usage changes, improving the electronic network resource usage efficiency by implementing, within the electronic network, the set of network configuration changes.

In the method, the utilizing perturbation theory may comprise verifying, by implementing at least one from among a test set of network configuration changes and a test set of electronic network resource usage changes, the perturbing of the plurality of network configurations and the plurality of usage factors.

In the method, the reconfiguration guide may indicate how the electronic network resource usage attributes respond to electronic network resource usage changes with respect to the plurality of network configurations; the reconfiguration guide may comprise a network resource usage response graph that correlates, to a respectively corresponding responsive state of operation including a set of respectively corresponding electronic network resource attribute responses, each network resource usage configuration change from among a range of network configuration changes; and each network resource usage configuration change may comprise at least one from among a respectively corresponding network setting change and a respectively corresponding electronic network resource usage change.

In the method, the reconfiguration dataset may comprise a set of electronic network resource parameters that is defined as:

$$d = {\{ {x}_{i} \}}_{i = 1}^{N} ⊂ {ℝ}^{d} ,$$

wherein xᵢ represents a d-dimensional feature vector of the electronic network.

In the method, the perturbing may comprise a first perturbation function that is defined as:

$$ϕ \text{:} {ℝ}^{d} \times 𝒜 \to Δ ( {ℝ}^{d} ) ,$$

wherein [symbol] represents a set of electronic network resource usage configuration constraints.

In the method, the perturbing may comprise: generating, for each network resource state from among a plurality of network resource states, a respectively corresponding group of network configuration changes; and the generating may comprise applying, for each data point of a respectively corresponding d-dimensional feature vector xᵢ of the network resource state and for each respectively corresponding electronic network resource usage attribute from among a plurality of electronic network resource usage attributes that respectively correspond to the network resource state, an iterative perturbation function that is defined as:

$${x}_{i}^{′} [ f ] = \{ \begin{matrix}\sim Uniform ( {categories}_{f} ) & if f is categorical \\ {x}_{i} [ f ] + ϵ \text{:} ϵ \sim {ε}_{f} & if f is continuous\end{matrix} ,$$

wherein x′ᵢ comprises a perturbed version of the respectively corresponding d-dimensional feature vector xᵢ, Uniform (categories_{f}) comprises a uniform distribution over categories, [symbol] comprises a finite set of perturbations for a continuous feature, and each electronic network resource usage attribute comprises a feature that is defined as f∈{1, . . . , d}.

In the method, the determining may comprise transmitting, at least one respectively corresponding group of network configuration changes from among a plurality of groups of network configuration changes that comprises each respectively corresponding group of network configuration changes that is generated, to at least one artificial intelligence and machine learning (AI/ML) model.

In the method, the at least one AI/ML model may comprise a large language model (LLM).

In the method, the at least one respectively corresponding group of network configuration changes may comprise no more than a quantity of N² respectively corresponding groups of network configuration changes.

In the method, the determining may further comprise utilizing the at least one AI/ML model to train a network resource usage efficiency cost function C that is defined as:

$$C \text{:} {ℝ}^{d} \times {ℝ}^{d} \to {ℝ}_{\geq 0} .$$

According to another aspect of the present invention, a system is provided that implements an electronic network reconfiguration tool that improves electronic network resource usage efficiency within an electronic network. The system may comprise a processor and memory storing instructions that, when executed by the processor, cause the processor to perform operations. In the system, the operations may comprise: storing, as a reconfiguration dataset, electronic network resource parameters that describe electronic network resource usage attributes of the electronic network; utilizing perturbation theory, to generate a reconfiguration guide of the reconfiguration dataset, by perturbing a plurality of network configurations and a plurality of usage factors of the electronic network resource usage attributes; during a first state of operation that comprises a first electronic network resource usage state, receiving a first set of electronic network resource usage changes; based on the first state of operation, determining, by evaluating the first set of electronic network resource usage changes against the reconfiguration guide, a set of network configuration changes that improves the electronic network resource usage efficiency; and based on the first state of operation and the first set of electronic network resource usage changes, improving the electronic network resource usage efficiency by implementing, within the electronic network, the set of network configuration changes.

In the system, when executed by the processor, the instructions may cause the utilizing perturbation theory to comprise verifying, by implementing at least one from among a test set of network configuration changes and a test set of electronic network resource usage changes, the perturbing of the plurality of network configurations and the plurality of usage factors.

In the system, when the instructions are executed by the processor: the reconfiguration guide may indicate how the electronic network resource usage attributes respond to electronic network resource usage changes with respect to the plurality of network configurations; the reconfiguration guide may comprise a network resource usage response graph that correlates, to a respectively corresponding responsive state of operation including a set of respectively corresponding electronic network resource attribute responses, each network resource usage configuration change from among a range of network configuration changes; and each network resource usage configuration change may comprise at least one from among a respectively corresponding network setting change and a respectively corresponding electronic network resource usage change.

In the system, when the instructions are executed by the processor, the reconfiguration dataset may comprise a set of electronic network resource parameters that is defined as:

$$d = {\{ {x}_{i} \}}_{i = 1}^{N} ⊂ {ℝ}^{d} ,$$

wherein xᵢ represents a d-dimensional feature vector of the electronic network.

In the system, when the instructions are executed by the processor, the perturbing may comprise a first perturbation function that is defined as:

$$ϕ : {ℝ}^{d} \times 𝒜 \to Δ ( {ℝ}^{d} ) ,$$

wherein [symbol] represents a set of electronic network resource usage configuration constraints.

In the system, when executed by the processor: the instructions may cause the perturbing to comprise generating, for each network resource state from among a plurality of network resource states, a respectively corresponding group of network configuration changes; and the instructions may cause the generating to comprise applying, for each data point of a respectively corresponding d-dimensional feature vector xᵢ of the network resource state and for each respectively corresponding electronic network resource usage attribute from among a plurality of electronic network resource usage attributes that respectively correspond to the network resource state, an iterative perturbation function that is defined as:

$${x}_{i}^{′} [ f ] = \{ \begin{matrix}∼ Uniform ( {categories}_{f} ) & if f is categorical \\ {x}_{i} [ f ] + ϵ : ϵ ∼ {ε}_{f} & if f is continuous\end{matrix} ,$$

wherein x′ᵢ comprises a perturbed version of the respectively corresponding d-dimensional feature vector xᵢ, Uniform (categories_{f}) comprises a uniform distribution over categories, [symbol] comprises a finite set of perturbations for a continuous feature, and each electronic network resource usage attribute comprises a feature that is defined as f∈{1, . . . , d}.

In the system, when executed by the processor, the instructions may cause the determining to comprise transmitting, at least one respectively corresponding group of network configuration changes from among a plurality of groups of network configuration changes that comprises each respectively corresponding group of network configuration changes that is generated, to at least one AI/ML model.

In the system, when the instructions are executed by the processor, the at least one AI/ML model may comprise an LLM.

In the system, when the instructions are executed by the processor, the at least one respectively corresponding group of network configuration changes may comprise no more than a quantity of N² respectively corresponding groups of network configuration changes.

In the system, when executed by the processor, the instructions may cause the determining to further comprise utilizing the at least one AI/ML model to train a network resource usage efficiency cost function C that is defined as:

$$C : {ℝ}^{d} \times {ℝ}^{d} \to {ℝ}_{\geq 0} .$$

According to yet another aspect of the present disclosure, a non-transitory computer-readable medium is presented that implements an electronic network reconfiguration tool that improves electronic network resource usage efficiency within an electronic network. The computer-readable medium may store instructions that, when executed by a processor, cause the processor to perform operations. In the computer-readable medium, the operations may comprise: storing, as a reconfiguration dataset, electronic network resource parameters that describe electronic network resource usage attributes of the electronic network; utilizing perturbation theory, to generate a reconfiguration guide of the reconfiguration dataset, by perturbing a plurality of network configurations and a plurality of usage factors of the electronic network resource usage attributes; during a first state of operation that comprises a first electronic network resource usage state, receiving a first set of electronic network resource usage changes; based on the first state of operation, determining, by evaluating the first set of electronic network resource usage changes against the reconfiguration guide, a set of network configuration changes that improves the electronic network resource usage efficiency; and based on the first state of operation and the first set of electronic network resource usage changes, improving the electronic network resource usage efficiency by implementing, within the electronic network, the set of network configuration changes.

In the computer-readable medium, when executed by the processor, the instructions may cause the utilizing perturbation theory to comprise verifying, by implementing at least one from among a test set of network configuration changes and a test set of electronic network resource usage changes, the perturbing of the plurality of network configurations and the plurality of usage factors.

In the computer-readable medium, when the instructions are executed by the processor: the reconfiguration guide may indicate how the electronic network resource usage attributes respond to electronic network resource usage changes with respect to the plurality of network configurations, the reconfiguration guide may comprise a network resource usage response graph that correlates, to a respectively corresponding responsive state of operation including a set of respectively corresponding electronic network resource attribute responses, each network resource usage configuration change from among a range of network configuration changes, and each network resource usage configuration change may comprise at least one from among a respectively corresponding network setting change and a respectively corresponding electronic network resource usage change.

In the computer-readable medium, when the instructions are executed by the processor, the reconfiguration dataset may comprise a set of electronic network resource parameters that is defined as:

$$d = {\{ {x}_{i} \}}_{i = 1}^{N} ⊂ {ℝ}^{d} ,$$

wherein xᵢ represents a d-dimensional feature vector of the electronic network.

In the computer-readable medium, when the instructions are executed by the processor, the perturbing may comprises a first perturbation function that is defined as:

$$ϕ : {ℝ}^{d} \times 𝒜 \to Δ ( {ℝ}^{d} ) ,$$

wherein [symbol] represents a set of electronic network resource usage configuration constraints.

In the computer-readable medium, when executed by the processor: the instructions may cause the perturbing to comprise generating, for each network resource state from among a plurality of network resource states, a respectively corresponding group of network configuration changes; and the instructions may cause the generating to comprise applying, for each data point of a respectively corresponding d-dimensional feature vector xᵢ of the network resource state and for each respectively corresponding electronic network resource usage attribute from among a plurality of electronic network resource usage attributes that respectively correspond to the network resource state, an iterative perturbation function that is defined as:

$${x}_{i}^{′} [ f ] = \{ \begin{matrix}∼ Uniform ( {categories}_{f} ) & if f is categorical \\ {x}_{i} [ f ] + ϵ : ϵ ∼ {ε}_{f} & if f is continuous\end{matrix} ,$$

wherein x′ᵢ comprises a perturbed version of the respectively corresponding d-dimensional feature vector xᵢ, Uniform (categories_{f}) comprises a uniform distribution over categories, ε_{f} comprises a finite set of perturbations for a continuous feature, and each electronic network resource usage attribute comprises a feature that is defined as f∈{1, . . . , d}.

In the computer-readable medium, when executed by the processor, the instructions may cause the determining to comprise transmitting, at least one respectively corresponding group of network configuration changes from among a plurality of groups of network configuration changes that comprises each respectively corresponding group of network configuration changes that is generated, to at least one AI/ML model.

In the computer-readable medium, when the instructions are executed by the processor, the at least one AI/ML model may comprise an LLM.

In the computer-readable medium, when the instructions are executed by the processor, the at least one respectively corresponding group of network configuration changes may comprise no more than a quantity of N² respectively corresponding groups of network configuration changes.

In the computer-readable medium, when executed by the processor, the instructions may cause the determining to further comprise utilizing the at least one AI/ML model to train a network resource usage efficiency cost function C that is defined as:

$$C : {ℝ}^{d} \times {ℝ}^{d} \to {ℝ}_{\geq 0} .$$

Accordingly, the invention disclosed herein provides an electronic network reconfiguration tool that improves electronic network resource usage efficiency within an electronic network.

### BRIEF DESCRIPTION OF THE DRAWINGS

The present disclosure is further described in the detailed description which follows, in reference to the noted plurality of drawings, by way of non-limiting examples of the present disclosure, in which like characters represent like elements throughout the several views of the drawings.

FIG. 1 depicts a diagram of computer system, according to an embodiment.

FIG. 2 depicts a diagram of an environment for implementing an electronic network reconfiguration tool, according to an embodiment.

FIG. 3 depicts a diagram of a perspective of an environment that is configured to implement an electronic network reconfiguration tool, according to an embodiment.

FIG. 4 depicts a flowchart of a process for implementing an electronic network reconfiguration tool, according to an embodiment.

FIG. 5 depicts a flowchart of a process for training an electronic network reconfiguration tool, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out operations necessary to implement the methods of the examples of this technology that are described and illustrated herein.

As described in further detail below, the herein-disclosed technology reconfigures electronic network configurations to improve electronic network resource usage efficiency.

Accordingly, by employing the herein-disclosed technique within one or more electronic networks and thereby improving electronic network resource usage efficiency, the technique disclosed herein provides a technical improvement to existing electronic networks, particularly large-scale and/or enterprise networks.

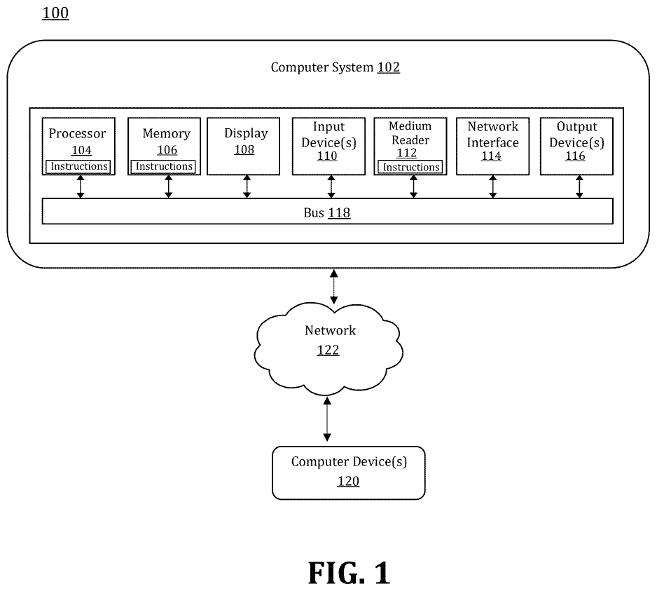

FIG. 1 is a system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for longer than a transitory period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely examples and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described in further detail below, the various embodiments disclosed herein provide methods, systems and computer-readable media for reconfiguring electronic network configurations to improve electronic network resource usage efficiency, such as, in response to one or more electronic network resource usage changes.

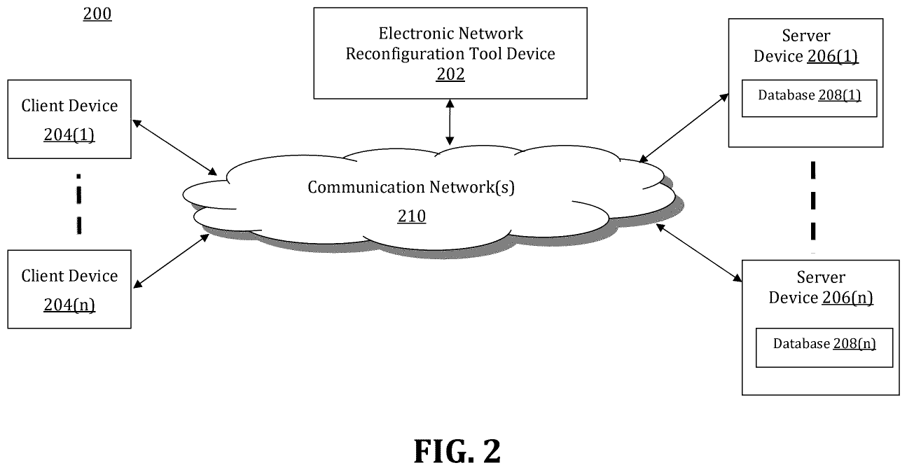

Referring to FIG. 2, a schematic of a network environment 200 for implementing an electronic network reconfiguration tool. In an embodiment, the electronic network reconfiguration tool may be implemented on any networked computer platform, such as, for example, a personal computer (PC).

A method for reconfiguring electronic network configurations to improve electronic network resource usage efficiency, may be implemented by an electronic network reconfiguration tool (ENRT) device 202. The ENRT device 202 may be the same or similar to the computer system 102 as described with respect to FIG. 1. The ENRT device 202 may be a rack-mounted server in a datacenter, an embedded microcontroller (MCU) in an electronic device, or another type of headless system, which is a computer system or device that is configured to operate without a monitor, keyboard and mouse. The ENRT device 202 may store one or more applications that can include executable instructions that, when executed by the ENRT device 202, cause the ENRT device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ENRT device 202 itself, may be located in virtual server(s) running in a cloud-based computing environment rather than being tied to one or more specific physical network computing devices. Also, the application(s) may be running in one or more virtual machines (VMs) executing on the ENRT device 202. Additionally, in one or more embodiments of this technology, virtual machine(s) running on the ENRT device 202 may be managed or supervised by a hypervisor.

In the network environment 200 of FIG. 2, the ENRT device 202 is coupled to a plurality of client devices 204(1)-204(n), and also to a plurality of server devices 206(1)-206(n) that hosts a plurality of databases 208(1)-208(n) via communication network(s) 210. A communication interface of the ENRT device 202, such as the network interface 114 of the computer system 102 of FIG. 1, operatively couples and communicates between the ENRT device 202, the client devices 204(1)-204(n), and/or the server devices 206(1)-206(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ENRT device 202, the client devices 204(1)-204(n), and/or the server devices 206(1)-206(n) may be coupled together via other topologies. Additionally, the network environment 200 may include other network devices such as one or more routers and/or switches, for example, which are well known in the art and thus will not be described herein. This technology provides a number of advantages including methods, computer readable media, and ENRT devices that implement a method for an electronic network reconfiguration tool that reconfigures electronic network configurations to improve electronic network resource usage efficiency.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. For the purposes of the present disclosure, it should be noted that: the term “remote” may refer to a “physical” and/or “virtual” remoteness; and the term “local” may refer to a “physical” and/or “virtual” locale.

The ENRT device 202 may be a standalone device or integrated with one or more other devices or apparatuses, such as one or more of the server devices 206(1)-206(n), for example. In one particular example, the ENRT device 202 may include or be hosted by one of the server devices 206(1)-206(n), and other arrangements are also possible. As another example, the ENRT device 202 may be integrated with one or more other devices or apparatuses, such as one or more of the client devices 204(1)-204(n). Moreover, one or more of the devices of the ENRT device 202 may be in a same or a different communication network including one or more public, private, or cloud networks, for example.

The plurality of server devices 206(1)-206(n) may be the same or similar to the computer system 102 or the computer device 120 as described with respect to FIG. 1, including any features or combination of features described with respect thereto. For example, any of the server devices 206(1)-206(n) may include, among other features, one or more processors, memories and communication interfaces, which are coupled together by at least one bus or other communication link, although other numbers and/or types of network devices may be used. The server devices 206(1)-206(n) in this example may process requests received from the ENRT device 202 via the communication network(s) 210 according to an HTTP-based and/or JavaScript Object Notation (JSON) protocol, for example, although other protocols may also be used.

The server devices 206(1)-206(n) may be hardware or software or may represent a system with multiple servers in a pool, which may include internal or external networks. The server devices 206(1)-206(n) hosts the databases 208(1)-208(n) that are configured to store data.

Although the server devices 206(1)-206(n) are illustrated as single devices, one or more actions of each of the server devices 206(1)-206(n) may be distributed across one or more distinct network computing devices that together comprise one or more of the server devices 206(1)-206(n). Moreover, the server devices 206(1)-206(n) are not limited to a particular configuration. Thus, the server devices 206(1)-206(n) may contain a plurality of network computing devices that operate using a master/slave approach, whereby one of the network computing devices of the server devices 206(1)-206(n) operates to manage and/or otherwise coordinate operations of the other network computing devices.

The server devices 206(1)-206(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures are also envisaged.

The plurality of client devices 204(1)-204(n) may also be the same or similar to the computer system 102 or the computer device 120 as described with respect to FIG. 1, including any features or combination of features described with respect thereto. For example, the client devices 204(1)-204(n) in this example may include any type of computing device that can interact with the ENRT device 202 via communication network(s) 210. Accordingly, the client devices 204(1)-204(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 204 is a wireless mobile communication device, i.e., a smart phone.

The client devices 204(1)-204(n) may run interface applications, such as standard web browsers or standalone client applications, which may provide an interface to communicate with the ENRT device 202 via the communication network(s) 210 in order to communicate user requests and other information. The client devices 204(1)-204(n) may further include, among other features, a display device, such as a display screen or touchscreen, and/or an input device, such as a keyboard, for example. The client devices 204(1)-204(n) may host one or more applications that are proprietary to an enterprise that may be secured against eavesdropping, and these applications may be distributed among client devices 204(1)-204(n). The enterprise's distributed applications may include software that is based on microservices architecture, for example.

Although the network environment 200 with the ENRT device 202, the client devices 204(1)-204(n), the server devices 206(1)-206(n), the databases 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ENRT device 202, the client devices 204(1)-204(n), the server devices 206(1)-206(n), and the databases 208(1)-208(n), for example, may be configured to operate as virtual instances on the same physical machine. In other words, one or more of the ENRT device 202, the server devices 206(1)-206(n), the client devices 204(1)-204(n), and the databases 208(1)-208(n) may operate on a common physical device rather than as separate devices communicating through communication network(s) 210. Additionally, there may be more or fewer client devices 204(1)-204(n), server devices 206(1)-206(n), and databases 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

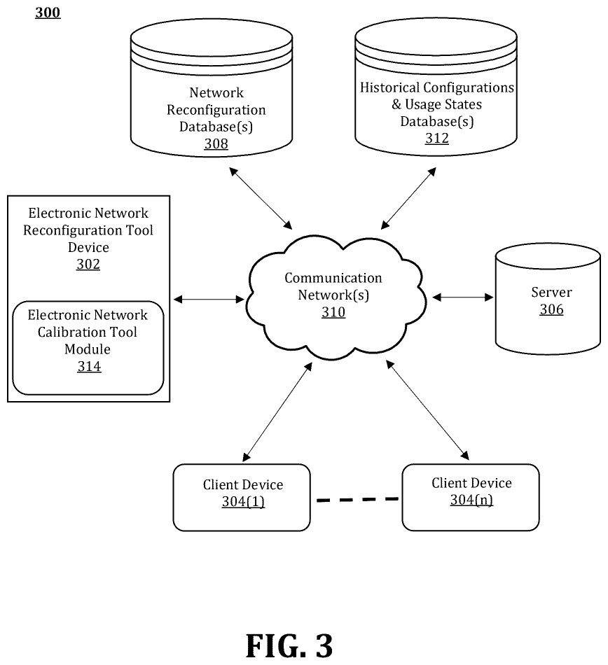

The ENRT device 302 is described and illustrated in FIG. 3 as including electronic network reconfiguration tool module 314, although it may include other rules, policies, modules, databases, or applications, for example. As will be described below, electronic network reconfiguration tool module 314 is configured to reconfigure electronic network configurations (e.g., electronic network resource usage configurations) within at least one electronic transmission network, such as communication network(s) 310, for example. Electronic network reconfiguration tool module 314 may include software that is based on microservices architecture, for example.

Electronic network reconfiguration tool module 314 may be integrated with one or more devices or apparatuses, such as client devices 304(1)-304(n), where electronic network reconfiguration tool module 314 may be implemented as an application or as an addon or plugin to another application of the one or more devices or apparatuses, and where electronic network reconfiguration tool module 314 may execute in the background.

A configuration 300 for applying an electronic network reconfiguration tool to an aspect of the network environment of FIG. 2 is illustrated as being executed in FIG. 3. Specifically, client devices 304(1)-304(n) are illustrated as being in communication with ENRT device 302. In this regard, a first client device 304(1) and at least a second client device 304(2) may be “clients” of the ENRT device 302 and are described herein as such. Nevertheless, it is to be known and understood that client device 304(1) and/or at least client device 304(2) need not necessarily be “clients” of the ENRT device 302, or any entity described in association therewith herein. Any additional or alternative relationship may exist between client device 304(1), client device 304(2) and ENRT device 302.

Electronic network reconfiguration tool module 314 of ENRT device 302 may communicate with at least one database, such as one or more network reconfiguration database(s) 308. Thereby, as described in further detail below, ENRT device 302 may utilize one or more local and/or network repositories to store at least one from among data, parameters, features, attributes, algorithms, software, datasets and/or other information for reconfiguring at least one electronic network.

In addition, electronic network reconfiguration tool module 314 of ENRT device 302 may also communicate with one or more historical configurations and usage states database(s) 312. Thereby, as described in further detail below, ENRT device 302 may obtain historical network resource usage configuration data and/or historical network resource usage state information from one or more historical configurations and usage states database(s) 312.

In an embodiment, electronic network reconfiguration tool module 314 may be configured to provide a dynamically customizable interface for selecting, to communicate with, at least one server device at least one from among server devices 306(1)-306(n). Moreover, ENRT device 302 may receive and transmit data via communication network(s) 210. ENRT device 302 may receive and transmit data such as code that is written in one or more of the following dialects: transaction control language (TCL), data manipulation language (DML), data control language (DCL) and data definition language (DDL). Additionally, via communication network(s) 310, ENRT device 302 may respectively receive and transmit data from and to one or more from among client devices 304(1)-304(n) and the server devices 306(1)-306(n).

However, FIG. 3 depicts client device 304(1) and at least client device 304(n) as belonging to communication network(s) 310, and ENRT device 302 may communicate with any one or more devices or apparatuses that belong to the communication network(s) 310, such as one or more from among client devices 304(1)-304(n). For example, ENRT device 302 may utilize a graphical user interface (GUI) to communicate with one or more from among client devices 304(1)-304(n), and communication network(s) 310 may comprise a cluster that belongs to the above-mentioned enterprise that may be secured against eavesdropping. In a further embodiment, communication network(s) 310 may comprise a cluster of distributed applications that belong to the enterprise.

Client device 304(1) may be, for example, a smart phone. Of course, client device 304(1) may be any additional device described herein. Client device 304(n) may be, for example, a personal computer (PC). Of course, client device 304(n) may also be any additional device described herein.

The client devices 304(1)-304(n) may represent, for example, computer systems of the enterprise's client network. Client device 304(1) may represent, for example, one or more computer systems of a client or of a cluster of clients within the enterprise or client network. Of course, client device 304(1) may include one or more of any of the devices described herein. Client device 304(n) may be, for example, one or more computer systems of another client or cluster of clients within the enterprise or client network. Of course, client device 304(n) may include one or more of any of the devices described herein.

The process may be executed via the communication network(s) 310, which may comprise plural networks as described above. For example, in an embodiment, either or both of client device 304(1) and client device 204(n) may communicate with the ENRT device 302 via broadband or cellular communication. Of course, these embodiments are merely exemplary and are not limiting or exhaustive.

Electronic network reconfiguration tool module 314 may programmatically configure and communicate with server devices 306(1)-306(n), which may respectively correspond to remote clusters of server devices, such as a server farm, for example.

Electronic network reconfiguration tool module 314 may execute a process that programmatically configures and communicates with one or more server devices from among server devices 306(1)-306(n). In some embodiments, at least one (and possibly each) from among server devices 306(1)-306(n) may comprise a processing platform that may be based on at least one AI/ML model, such as at least one from among at least one large language model (LLM), at least one neural network, and at least one generative AI/ML model.

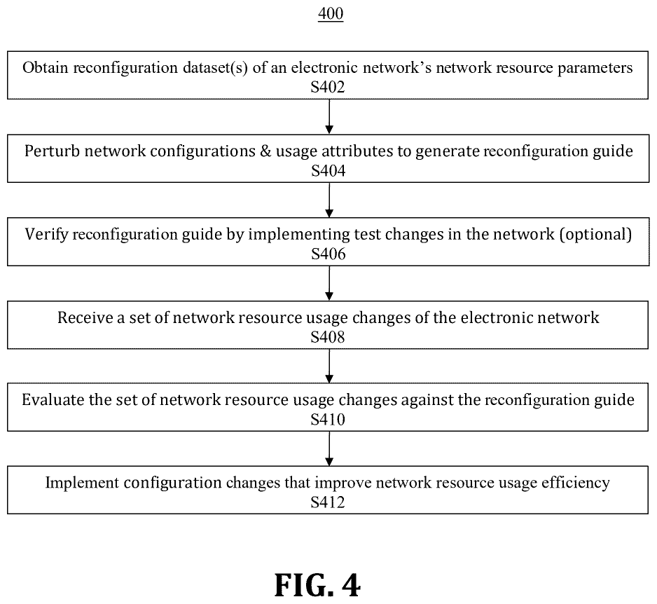

A process for an electronic network reconfiguration tool is generally indicated at flowchart 400 in FIG. 4. Process 400 may be performed to improve electronic network resource usage efficiency by reconfiguring electronic network configurations of at least one electronic network.

At step S402, the electronic network reconfiguration tool (such as electronic network reconfiguration tool 202, electronic network reconfiguration tool device 302 and/or electronic network reconfiguration tool module 314) may obtain, for and/or from storage as one or more reconfiguration datasets, electronic network resource parameters that describe electronic network resource usage attributes of the electronic network.

According to the present disclosure, at step S402, the electronic network reconfiguration tool may obtain the one or more reconfiguration datasets from at least one database, such as network reconfiguration database(s) 308, and the network reconfiguration datasets may be based on historical information, such as the contents of at least one historical database (e.g., historical configurations & usage states database(s) 312).

According to the present disclosure, the reconfiguration dataset(s) may comprise a set of electronic network resource parameters. Additionally, d may represent the reconfiguration dataset(s), and the reconfiguration dataset(s) may be defined by the equation:

$$d = {\{ {x}_{i} \}}_{i = 1}^{N} ⊂ {ℝ}^{d} ,$$

wherein xᵢ represents a d-dimensional feature vector of the electronic network.

At step S404, the electronic network reconfiguration tool may utilize perturbation theory, to generate a reconfiguration guide of the reconfiguration dataset, by perturbing a plurality of network configurations and a plurality of usage factors of the electronic network resource usage attributes.

According to the present disclosure, the perturbing may comprise a first perturbation function that may be defined by the equation:

$$ϕ : {ℝ}^{d} \times 𝒜 \to Δ ( {ℝ}^{d} ) ,$$

wherein [symbol] represents a set of electronic network resource usage configuration constraints.

In addition, the perturbing may comprise generating, for each network resource state from among a plurality of network resource states, a respectively corresponding group of network configuration changes. This generating operation may include applying, for each data point of a respectively corresponding d-dimensional feature vector xᵢ of the network resource state and for each respectively corresponding electronic network resource usage attribute from among a plurality of electronic network resource usage attributes that respectively correspond to the network resource state, an iterative perturbation function that may be defined by the equation:

$${x}_{i}^{′} [ f ] = \{ \begin{matrix}∼ Uniform ( {categories}_{f} ) & if f is categorical \\ {x}_{i} [ f ] + ϵ : ϵ ∼ {ε}_{f} & if f is continuous\end{matrix} ,$$

wherein x′ᵢ comprises a perturbed version of the respectively corresponding d-dimensional feature vector xᵢ, Uniform (categories_{f}) comprises a uniform distribution over categories, [symbol] comprises a finite set of perturbations for a continuous feature, and each electronic network resource usage attribute comprises a feature that is defined as f∈{1, . . . , d}.

In the perturbation function equation, x′ᵢ may represent a perturbed version of the respectively corresponding d-dimensional feature vector xᵢ, Uniform (categories_{f}) may represent a uniform distribution over categories, [symbol] may represent a finite set of perturbations for a continuous feature, and each electronic network resource usage attribute may represent a respectively corresponding feature that may each be generally defined by the following formula:

$$f ∈ \{ 1 , … , d \}$$

Accordingly, in process 400, the reconfiguration guide may indicate how the electronic network resource usage attributes respond to electronic network resource usage changes with respect to the plurality of network configurations. Additionally, the reconfiguration guide may comprise a network resource usage response graph that correlates each network resource usage configuration change from among a range of network configuration changes, to a respectively corresponding responsive state of operation including a set of respectively corresponding electronic network resource attribute responses. Moreover, each network resource usage configuration change may comprise at least one from among a respectively corresponding network setting change and a respectively corresponding electronic network resource usage change.

Optionally, at step S406, the electronic network reconfiguration tool may verify, by implementing at least one from among a test set of network configuration changes and a test set of electronic network resource usage changes, the perturbing of the plurality of network configurations and the plurality of usage factors.

During a first state of operation that comprises a first electronic network resource usage state, at step S408, the electronic network reconfiguration tool may receive a first set of electronic network resource usage changes.

By evaluating the first set of electronic network resource usage changes against the reconfiguration guide, at step S410, the electronic network reconfiguration tool may determine, based on the first state of operation, a set of network configuration changes that improves the electronic network resource usage efficiency.

According to the present disclosure, the determining may comprise transmitting, at least one respectively corresponding group of network configuration changes from among a plurality of groups of network configuration changes that comprises each respectively corresponding group of network configuration changes that is generated, to at least one artificial intelligence and machine learning (AI/ML) model, and the at least one AI/ML model may comprise a large language model (LLM).

In process 400, the determining may further comprise utilizing the at least one AI/ML model to train a network resource usage efficiency cost function, and the network resource usage efficiency cost function may represented by the variable C, which may be defined by the formula:

$$C : {ℝ}^{d} \times {ℝ}^{d} \to {ℝ}_{\geq 0}$$

In addition, the at least one respectively corresponding group of network configuration changes may comprise no more than a quantity of N² respectively corresponding groups of network configuration changes.

Based on the first state of operation and the first set of electronic network resource usage changes, at step S412, the electronic network reconfiguration tool may improve electronic network resource usage efficiency by implementing the set of network configuration changes within the electronic network.

It should be noted that according to the present invention, any and all of the information generated by the techniques described herein may be stored within and/or obtained from at least one database, such as network reconfiguration database(s) 308.

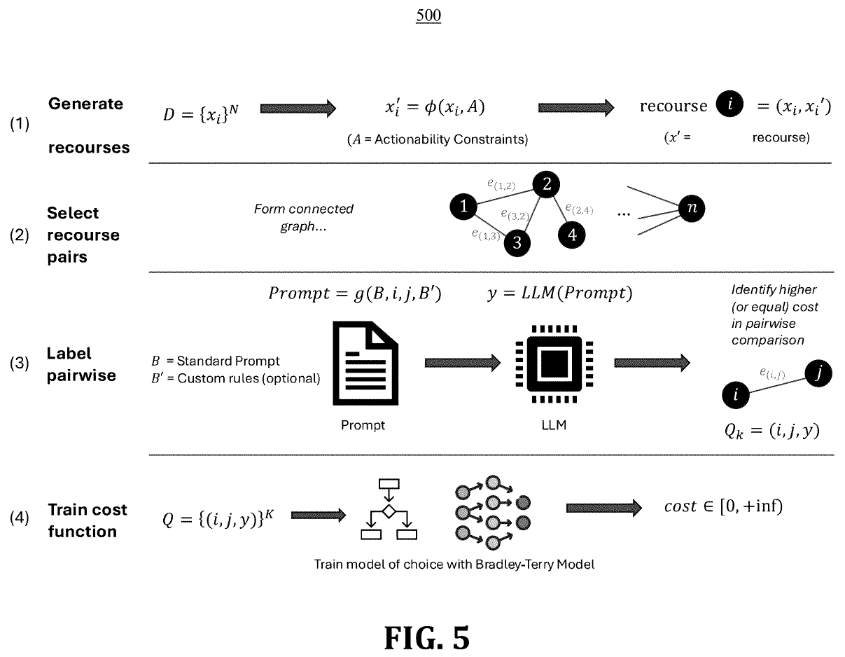

FIG. 5 depicts a flowchart of process 500, which comprises operations that may be utilized to train an electronic network reconfiguration tool that improves electronic network resource usage efficiency by reconfiguring an electronic network's resource configuration(s) based on the electronic network's load and/or the electronic network's resource availability (i.e., the resources that are available for the electronic network's use).

According to the present invention, process 500 may be performed by an electronic network reconfiguration tool (such as electronic network reconfiguration tool 202, electronic network reconfiguration tool device 302 and/or electronic network reconfiguration tool module 314).

Process 500 may begin when the electronic network reconfiguration tool performs the operations of (1), which may comprise utilizing perturbation theory to generate a set of actionability constraints (e.g., reconfigurations) by mathematically perturbing at least one parameter from among an electronic network resource parameter dataset (e.g., dataset d). Thereby, the operations of (1) may also comprise determining at least one recourse x′ᵢ, which may comprise reconfiguring electronic network resource configurations.

In process 500, according to the operations of (2), recourse pairs (e.g., reconfigurations), which represent network resource usage (and/or configuration) changes, may be utilized to generate a connected recourse graph that is based on the recourse pairs (e.g., network resource reconfigurations). The connected recourse graph that is generated by the operations of (2) may create and utilize a respectively corresponding association to connect each recourse pair (e.g., each reconfiguration) that is included within the connected recourse graph, with the connected recourse graph's recourse pairs that have a state (e.g., at least one from among the recourse pair's initial network resource usage configuration state and the recourse pair's reconfigured network resource usage configuration state) in common with one of the recourse pair's (e.g., the respectively corresponding recourse pair's) two states.

In process 500, the operations of (3) may comprise utilizing at least one AI/ML model (such as an LLM) to evaluate each recourse pair within the connected recourse graph, against each respectively corresponding recourse pair that has been associated with the recourse pair during the operations of (2).

As mentioned above, such respectively corresponding recourse pairs may be associated with the recourse pair by a respectively corresponding connection to a state of the recourse pair, where each state may comprise a set of network resource usage configurations. Thereby, for each of the connected recourse graph's connections, the operations of (3) may return a respectively corresponding cost (e.g., a network resource usage efficiency change).

In process 500, the operations of (4) may comprise utilizing the respectively corresponding costs that have been returned by the operations of (3), to train at least one AI/ML model (e.g., a transparent tree model) to reconfigure the electronic network's resource configuration(s) to improve the electronic network's resource usage efficiency.

Accordingly, the present invention may employ artificial intelligence technology and machine learning technology's vast knowledgebase to provide a flexible and scalable approach for acquiring network resource change efficiency costs. As disclosed herein, one or more AI/ML knowledgebases may be employed to determine the efficiency cost of various network resource usage configuration recourses, by calculating at least one network resource usage efficiency difference of a respectively corresponding pair of network resource usage configurations.

In other words, by determining network resource usage efficiencies for various respectively corresponding network resource usage configurations, the present invention may ascertain the most efficient network resource usage configuration for a particular network resource availability and/or network resource usage load. Thereby, at least one AI/ML knowledgebase may be employed to train at least one neural network to calculate network resource configuration change efficiency costs.

As discussed above, in order to ascertain network resource usage configuration recourses, a dataset of various network resource usage configurations and respectively corresponding network resource usage parameter attributes may be referred to as dataset d, which may be defined by the equation:

$$d = {\{ {x}_{i} \}}_{i = 1}^{N} ⊂ {ℝ}^{d} ,$$

wherein xᵢ represents a d-dimensional feature vector of an electronic network.

Accordingly, φ may represent a stochastic perturbation function, which may be defined by the equation:

$$ϕ : {ℝ}^{d} \times 𝒜 \to Δ ( {ℝ}^{d} ) ,$$

wherein [symbol] represents a set of electronic network resource usage configuration recourse constraints. Subsequently, a set of feature may then be selected from among a truncated geometric distribution that favors perturbations of a feature in order to address sparsity.

Hence, for each data point xᵢ and feature f∈{1, . . . , d} that is to be perturbed, a stochastic perturbation function may be applied according to the equation:

$${x}_{i}^{′} [ f ] = \{ \begin{matrix}∼ Uniform ( {categories}_{f} ) & if f is categorical \\ {x}_{i} [ f ] + ϵ : ϵ ∼ {ε}_{f} & if f is continuous\end{matrix} ,$$

wherein x′ᵢ comprises a perturbed version of the respectively corresponding d-dimensional feature vector xᵢ, Uniform (categories_{f}) comprises a uniform distribution over categories, [symbol] comprises a finite set of perturbations for a continuous feature, and each electronic network resource usage attribute comprises a feature that may be defined by the equation f∈{1, . . . , d}.

Thereby, a set of network resource usage configuration recourses may be generated. As disclosed herein, [symbol] may represent such a set of network resource usage configuration recourses, which may be defined by the equation

$$ℛ = {\{ ( {x}_{i} , {x}_{i}^{′} ) \}}_{i = 1}^{N} ,$$

where x′ᵢ represents a perturbed version of corresponding d-dimensional feature vector xᵢ. Accordingly, the present invention my compare different data points to each other from a network resource usage efficiency distribution curve of a specific network resource availability and/or a specific network resource usage load. As a result, such comparisons may be utilized to calculate network resource usage efficiency costs for the respectively corresponding network resource usage configuration changes.

Turning to recourse pair selection operations, a quantity of K≤N² recourse pairs may be selected from among the set of recourses [symbol] . The K≤N² recourse pairs may be selected to be transmitted to an AI/ML model (e.g., an LLM). This may be utilized to connect the recourses into a graph described above, which may include undirected graph structures. Within such as graph, each recourse pair may have a minimum of Kₘᵢₙ edges, and each recourse may have a path between every other recourse pair. Accordingly, performance of the final cost function is improved because such a graph permits the costs for all recourses to be estimated on a common scale.

Additionally, edges may be prioritized between recourse pairs which perturb a common continuous feature at two (2) different parts of its distribution by a first amount. This forces the AI/ML model's (e.g., LLM's) processing to return the cost, which may be the difference in efficiency between difference recourses (e.g., reconfigurations).

The graphs presented herein may also incorporate edges to enforce comparisons of common feature changes (e.g., resource usage change(s)) for various dependencies. The total additional edges from this enforcement may be set to 10% of the total data for both, which typically adds 20% extra data. Accordingly, the graph(s) presented herein may be constructed subject to a Kₘᵢₙ constraint. A random spanning tree algorithm may be employed for such construction.

According to the present invention, an AI/ML model, such as an LLM may be tasked with data labeling. At least one AI/ML model may be tasked with comparing two network resource usage states and their respective feature changes. The at least one AI/ML model may then be tasked with enumerating the features as well as their descriptions. Subsequently, the at least one AI/ML model may be tasked with calculating at least one most cost-efficient path or recourse, and the at least one AI/ML model may be tasked with responding with a label that indicates which recourse(s) is/are more efficient than others.

In addition, the at least one AI/ML model may also be tasked with indicating which recourses have the same efficiency, which is a useful de-biasing signal in contexts where features represent sensitive demographic attributes (e.g., low income and/or rural network resources, etc.). Moreover, the at least one AI/ML model may also be task with utilizing chain-of-thought processing to increase performance.

According to the approach provided herein, the at least one AI/ML model's prompt may be customized with a set of desired cost function parameters, denoted by B′. An output of this stage may comprise a set of K comparisons

$$Q = {\{ ( i , j , y ) \}}_{i = 1}^{N} ,$$

where i and j≠i are indices of a pair of recourse examples from [symbol] and y∈{0, 0, 5, 1} denotes the at least one AI/ML model's efficiency and/or cost calculation.

Subsequently, a dataset of the at least one AI/ML model's comparisons Q may be utilized to train a cost function C: [symbol] × [symbol] → [symbol] . At least one Bradley-Terry model may be utilized to train such a cost function. Given a cost function C and a pair of recourses (xᵢ,x′ᵢ) and (xⱼ,x′ⱼ), where C's predicted comparison probability may be defined as:

$$\text{?} ( i , j ) = \frac{1}{1 + exp ( 𝒞 ( \text{?} ) - 𝒞 ( \text{?} ) )} .$$

$$\text{?} \text{indicates text missing or illegible when filed}$$

The cost function provided herein may minimize a binary cross-entropy between predicted comparison probabilities and the labels provided by the LLM across all training examples as provided by the equation:

$$arg \text{?} \text{?} [ - \sum \text{?} y log ( \text{?} ( i , j ) ) + ( 1 - y ) log ( 1 - \text{?} ( i , j ) ) ] ,$$

$$\text{?} \text{indicates text missing or illegible when filed}$$

where m is a chosen model class. This loss is differentiable, so m may be defined as a class of neural networks. Stochastic gradient descent may be utilized to train such a neural network.

As an alternative, a class of axis-aligned decision trees may also be utilized up to a maximum leaf count Lₘₐₓ, which offers greater transparency. A variety of algorithms may be utilized to train a non-differentiable tree with a pairwise Bradley-Terry loss. One-hot encode categorical features and concatenate the original data point x, the perturbed recourse point x′ and the feature-wise difference x′-x into a single vector [x, x′, x′−x]ϵ [symbol] .

According to the approach provided herein, final post processing operations may include shifting outputs of at least one (and as much as each) trained model to ≥0 on all training data, which has the advantage of having no impact on the Bradley-Terry loss and producing the expected behavior.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Therefore, applications of the present disclosure are not limited to electronic resource usage efficiency improvements and may be extended to provide a technical improvement to efforts in other technological areas.

Accordingly, although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method of implementing an electronic network reconfiguration tool that improves electronic network resource usage efficiency within an electronic network, the method comprising:
storing, as a reconfiguration dataset, electronic network resource parameters that describe electronic network resource usage attributes of the electronic network;
utilizing perturbation theory, to generate a reconfiguration guide of the reconfiguration dataset, by perturbing a plurality of network configurations and a plurality of usage factors of the electronic network resource usage attributes;
during a first state of operation that comprises a first electronic network resource usage state, receiving a first set of electronic network resource usage changes;
based on the first state of operation, determining, by evaluating the first set of electronic network resource usage changes against the reconfiguration guide, a set of network configuration changes that improves the electronic network resource usage efficiency; and
based on the first state of operation and the first set of electronic network resource usage changes, improving the electronic network resource usage efficiency by implementing, within the electronic network, the set of network configuration changes.

2. The method of claim 1, wherein the utilizing perturbation theory comprises:
verifying, by implementing at least one from among a test set of network configuration changes and a test set of electronic network resource usage changes, the perturbing of the plurality of network configurations and the plurality of usage factors.

3. The method of claim 1,
wherein the reconfiguration guide indicates how the electronic network resource usage attributes respond to electronic network resource usage changes with respect to the plurality of network configurations,
wherein the reconfiguration guide comprises a network resource usage response graph that correlates, to a respectively corresponding responsive state of operation including a set of respectively corresponding electronic network resource attribute responses, each network resource usage configuration change from among a range of network configuration changes, and
wherein each network resource usage configuration change comprises at least one from among a respectively corresponding network setting change and a respectively corresponding electronic network resource usage change.

4. The method of claim 1, wherein the reconfiguration dataset comprises a set of electronic network resource parameters that is defined as:
$$d = {\{ {x}_{i} \}}_{i = 1}^{N} ⊂ {ℝ}^{d} ,$$
wherein xᵢ represents a d-dimensional feature vector of the electronic network.

5. The method of claim 4, wherein the perturbing comprises a first perturbation function that is defined as:
$$ϕ : {ℝ}^{d} \times 𝒜 \to Δ ( {ℝ}^{d} ) ,$$
wherein [symbol] represents a set of electronic network resource usage configuration constraints.

6. The method of claim 4, wherein the perturbing comprises:
generating, for each network resource state from among a plurality of network resource states, a respectively corresponding group of network configuration changes, wherein the generating comprises:
applying, for each data point of a respectively corresponding d-dimensional feature vector xᵢ of the network resource state and for each respectively corresponding electronic network resource usage attribute from among a plurality of electronic network resource usage attributes that respectively correspond to the network resource state, an iterative perturbation function that is defined as:
$${x}_{i}^{′} [ f ] = \{ \begin{matrix}∼ Uniform ( {categories}_{f} ) & if f is categorical \\ {x}_{i} [ f ] + ϵ : ϵ ∼ {ε}_{f} & if f is continuous\end{matrix} ,$$
wherein x′ᵢ comprises a perturbed version of the respectively corresponding d-dimensional feature vector xᵢ, Uniform (categories_{f}) comprises a uniform distribution over categories, ε_{f} comprises a finite set of perturbations for a continuous feature, and each electronic network resource usage attribute comprises a feature that is defined as f∈{1, . . . , d}.

7. The method of claim 4, wherein the determining comprises:
transmitting, at least one respectively corresponding group of network configuration changes from among a plurality of groups of network configuration changes that comprises each respectively corresponding group of network configuration changes that is generated, to at least one artificial intelligence and machine learning (AI/ML) model.

8. The method of claim 7, wherein the at least one AI/ML model comprises a large language model (LLM).

9. The method of claim 7, wherein the at least one respectively corresponding group of network configuration changes comprises:
no more than a quantity of N² respectively corresponding groups of network configuration changes.

10. The method of claim 7, wherein the determining further comprises:
utilizing the at least one AI/ML model to train a network resource usage efficiency cost function C that is defined as:
$$C : {ℝ}^{d} \times {ℝ}^{d} \to {ℝ}_{\geq 0} .$$

11. A system of implementing an electronic network reconfiguration tool that improves electronic network resource usage efficiency within an electronic network, the system comprising:
a processor; and
memory storing instructions that, when executed by the processor, cause the processor to perform operations that comprise:
storing, as a reconfiguration dataset, electronic network resource parameters that describe electronic network resource usage attributes of the electronic network;
utilizing perturbation theory, to generate a reconfiguration guide of the reconfiguration dataset, by perturbing a plurality of network configurations and a plurality of usage factors of the electronic network resource usage attributes;
during a first state of operation that comprises a first electronic network resource usage state, receiving a first set of electronic network resource usage changes;
based on the first state of operation, determining, by evaluating the first set of electronic network resource usage changes against the reconfiguration guide, a set of network configuration changes that improves the electronic network resource usage efficiency; and
based on the first state of operation and the first set of electronic network resource usage changes, improving the electronic network resource usage efficiency by implementing, within the electronic network, the set of network configuration changes.

12. The system of claim 11, wherein when the instructions are executed by the processor, the reconfiguration dataset comprises a set of electronic network resource parameters that is defined as:
$$d = {\{ {x}_{i} \}}_{i = 1}^{N} ⊂ {ℝ}^{d} ,$$
wherein xᵢ represents a d-dimensional feature vector of the electronic network.

13. The system of claim 12, wherein when the instructions are executed by the processor, the perturbing comprises a first perturbation function that is defined as:
$$ϕ : {ℝ}^{d} \times 𝒜 \to Δ ( {ℝ}^{d} ) ,$$
wherein [symbol] represents a set of electronic network resource usage configuration constraints.

14. The system of claim 12, wherein when executed by the processor, the instructions cause the perturbing to comprise:
generating, for each network resource state from among a plurality of network resource states, a respectively corresponding group of network configuration changes, wherein the generating comprises:
applying, for each data point of a respectively corresponding d-dimensional feature vector xᵢ of the network resource state and for each respectively corresponding electronic network resource usage attribute from among a plurality of electronic network resource usage attributes that respectively correspond to the network resource state, an iterative perturbation function that is defined as:
$${x}_{i}^{′} [ f ] = \{ \begin{matrix}∼ Uniform ( {categories}_{f} ) & if f is categorical \\ {x}_{i} [ f ] + ϵ : ϵ ∼ {ε}_{f} & if f is continuous\end{matrix} ,$$
wherein x′ᵢ comprises a perturbed version of the respectively corresponding d-dimensional feature vector xᵢ, Uniform (categories_{f}) comprises a uniform distribution over categories, [symbol] comprises a finite set of perturbations for a continuous feature, and each electronic network resource usage attribute comprises a feature that is defined as f∈{1, . . . , d}.

15. The system of claim 12, wherein when executed by the processor, the instructions cause the determining to comprise:
transmitting, at least one respectively corresponding group of network configuration changes from among a plurality of groups of network configuration changes that comprises each respectively corresponding group of network configuration changes that is generated, to at least one artificial intelligence and machine learning (AI/ML) model.

16. The system of claim 15, wherein when executed by the processor, the instructions cause the determining to further comprise:
utilizing the at least one AI/ML model to train a network resource usage efficiency cost function C that is defined as:
$$C : {ℝ}^{d} \times {ℝ}^{d} \to {ℝ}_{\geq 0} .$$

17. A non-transitory computer-readable medium that implements an electronic network reconfiguration tool that improves electronic network resource usage efficiency within an electronic network, the computer-readable medium storing instructions that, when executed by a processor, cause the processor to perform operations that comprise:
storing, as a reconfiguration dataset, electronic network resource parameters that describe electronic network resource usage attributes of the electronic network;
utilizing perturbation theory, to generate a reconfiguration guide of the reconfiguration dataset, by perturbing a plurality of network configurations and a plurality of usage factors of the electronic network resource usage attributes;
during a first state of operation that comprises a first electronic network resource usage state, receiving a first set of electronic network resource usage changes;
based on the first state of operation, determining, by evaluating the first set of electronic network resource usage changes against the reconfiguration guide, a set of network configuration changes that improves the electronic network resource usage efficiency; and
based on the first state of operation and the first set of electronic network resource usage changes, improving the electronic network resource usage efficiency by implementing, within the electronic network, the set of network configuration changes.

18. The computer-readable medium of claim 17, wherein when executed by the processor, the instructions cause the utilizing perturbation theory to comprise:
verifying, by implementing at least one from among a test set of network configuration changes and a test set of electronic network resource usage changes, the perturbing of the plurality of network configurations and the plurality of usage factors.

19. The computer-readable medium of claim 17, wherein when the instructions are executed by the processor:
the reconfiguration guide indicates how the electronic network resource usage attributes respond to electronic network resource usage changes with respect to the plurality of network configurations,
the reconfiguration guide comprises a network resource usage response graph that correlates, to a respectively corresponding responsive state of operation including a set of respectively corresponding electronic network resource attribute responses, each network resource usage configuration change from among a range of network configuration changes, and
each network resource usage configuration change comprises at least one from among a respectively corresponding network setting change and a respectively corresponding electronic network resource usage change.

20. The computer-readable medium of claim 17, wherein the reconfiguration dataset comprises a set of electronic network resource parameters that is defined as:
$$d = {\{ {x}_{i} \}}_{i = 1}^{N} ⊂ {ℝ}^{d} ,$$
wherein xᵢ represents a d-dimensional feature vector of the electronic network, and
wherein, when executed by the processor, the instructions cause the perturbing to comprise:
generating, for each network resource state from among a plurality of network resource states, a respectively corresponding group of network configuration changes, wherein the generating comprises:
applying, for each data point of a respectively corresponding d-dimensional feature vector xᵢ of the network resource state and for each respectively corresponding electronic network resource usage attribute from among a plurality of electronic network resource usage attributes that respectively correspond to the network resource state, an iterative perturbation function that is defined as:
$${x}_{i}^{′} [ f ] = \{ \begin{matrix}∼ Uniform ( {categories}_{f} ) & if f is categorical \\ {x}_{i} [ f ] + ϵ : ϵ ∼ {ε}_{f} & if f is continuous\end{matrix} ,$$
wherein x′ᵢ comprises a perturbed version of the respectively corresponding d-dimensional feature vector xᵢ, Uniform (categories_{f}) comprises a uniform distribution over categories, [symbol] comprises a finite set of perturbations for a continuous feature, and each electronic network resource usage attribute comprises a feature that is defined as f∈{1, . . . , d}.
